(19) United States
(12) Patent Application Publication
(10) Pub. No.: US 2026/0216974 A1
(43) Pub. Date: Jul. 30, 2026

(54) METHOD OF PRODUCTION OF FRP COMPOSITE REBAR

(71) Applicant: LIMITED LIABILITY COMPANY COMPOSITE GROUP CHELYABINSK, Chelyabinsk (RU)

(72) Inventor: Ramanathan NEELAKANDAN KRISHNA, Chennai (IN)

(21) Appl. No.: 19/143,399

(22) PCT Filed: Dec. 27, 2023
(86) PCT No.: PCT/IN2023/051230

§ 371 Date: Jun. 26, 2025

(30) Foreign Application Priority Data
Dec. 27, 2022 (IN) 202241075923

(51) Int. Cl. B29C 70/52; B29C 70/06

(52) U.S. Cl. CPC B29C 70/521; B29C 70/06; B29C 70/528

(57) ABSTRACT

The invention relates to the technology of manufacturing reinforcing FRP composite elements for reinforcement of conventional and prestressed building structures.

With the help of manufacturing FRP composite rebar of the periodic profile, it includes the stretching of the formed and impregnated with a polymer binder cloth from roving threads through a squeezing device, which is assembled into a beam through a die, a feed to the periodic profile formation unit, a polymerization chamber, cooling blocks and cutting the product. At the same time, after the formation of the roving beam of the bearing rod in the die, pre-twisted threads are used as a periodic profile, and their application occurs with preliminary tension.

Thus, the quality of the produced rebar is greatly increased due to larger bonding strength. The strength of adhesion to concrete increases, due to the innovative process of a pre-tensioned roving periodic profile in the form of ribs along the length of the FRP composite rebar.

The invention relates to the technology of manufacturing rebar elements for reinforcement of conventional and prestressed building structures.

The technical result of the invention is to improve the quality of the produced rebar, namely to increase the strength of adhesion to concrete, due to the application of a periodic profile from the pre-twisted roving with preliminary tension.

EFFECT: The following is achieved by the fact that the production of FRP composite rebar of the periodic profile includes the pulling of the formed and impregnated rebar with a polymer binder web from roving threads through a squeezing device-that is assembled into a beam through a die, a feed to the periodic profile formation unit, a polymerization chamber, cooling blocks and cutting the product. According to the invention, after the formation of the roving beam of the bearing rod in the die, pre-twisted threads are used as a periodic profile, and their application is carried out with a preliminary tension.

In a particular case of the execution of the batch profile application method, the degree of twisting of the thread is regulated by the rotational speed of the platform for roving reels in the roving twisting device, and various automation elements can be used to minimize the deviation from the specified rotation revolutions of the platform drive.

In a particular case, the execution of the method of applying a periodic profile, applying a profile is carried out with a different period and/or at different angles.

In a particular case of execution of the method of applying a periodic profile, applying a profile is carried out using one, two or more simultaneously applied threads.

The formation of a periodic profile of twisted threads and a bearing rod made of fiberglass (the most common material today) and/or basalt fiber, and/or fiber angle, and/or aramid fiber, and/or their combination with pre-tension increases the characteristics of rebar for tearing out of concrete, improves adhesion to concrete, which increases its strength and performance characteristics.

The proposed method for the manufacture of FRP composite rebar is explained by the Figures mentioned below:

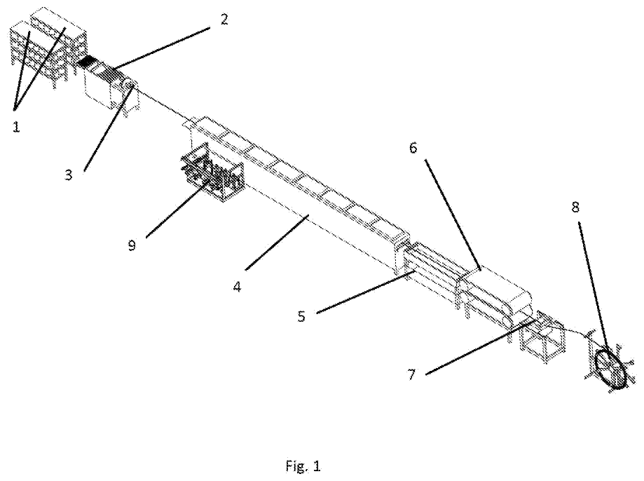

FIG. 1 is a block diagram of a process line

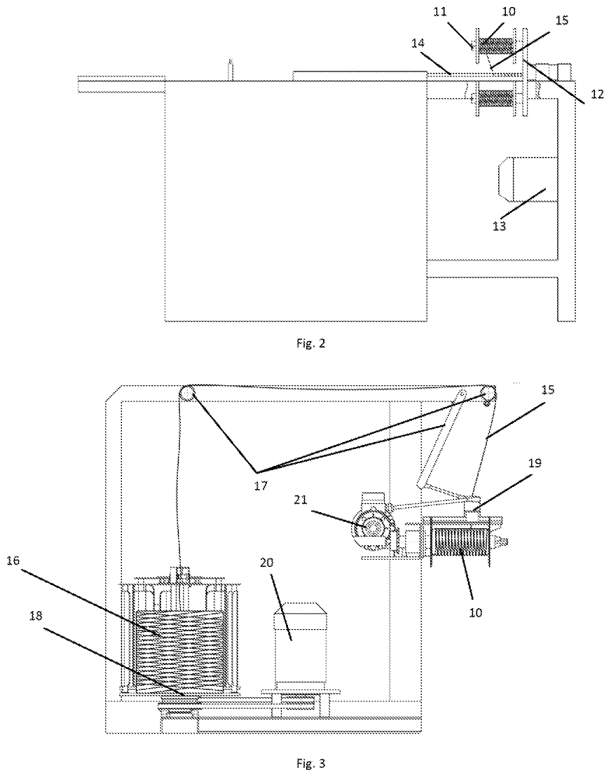

FIG. 2 is a schematic representation of an impregnation and spin unit equipped with a periodic roving profile application device;

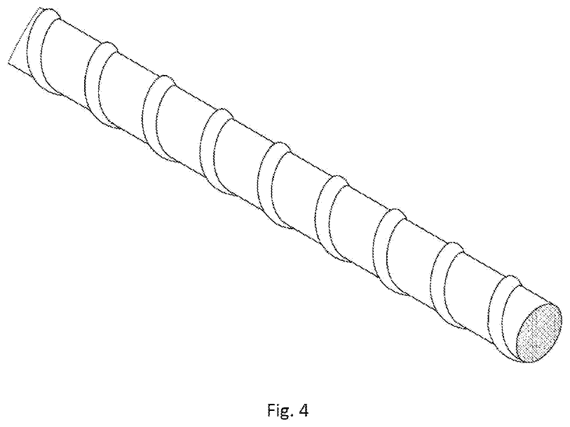

FIG. 3 is a schematic representation of a variant of a device designed for twisting a periodic profile;

FIG. 4 is schematic general view of the rod of FRP composite rebar produced by the declared method.

Initially, the rovings from the spools 1 is fed into the impregnation and spinning unit 2, where the binder is impregnated, squeezed (FIG. 1). The sprinkled and squeezed roving is collected in a die and formed into a bundle of 14 threads of the future rod.

The filament bundle then enters the periodic profile application device 3, where it passes through the center of the rotating flywheel 12 connected to the actuator 13, and a periodic profile is continuously applied along the radial surface from the spool 10 with twisted roving 15 mounted on the rotating flywheel 12. The spool 10 is tightened by a nut 11 to ensure pre-tension of the thread during application.

The periodic profile is formed from a filament 15 based on glass fibre and/or basalt fibre and/or carbon fibre and/or aramid fibre and/or a combination thereof, which has undergone a pre-axial twisting, e.g., in the roving twisting device 9, where the roving is rewound from the standard format vertical reels 16 (height 260 mm; diameter 185 mm; weighing 9-15 kg) passing through the rod system 17 to the spools 10 rotating under the action of the drive 21, while vertically mounted on platforms 18 reels 16 rotate around their axis nod action of the electric motor 20, thus twisting the roving threads in the process of rewinding them to the spools 10. The reciprocating gate of the shuttle unit 19, which is connected to the drive 21 through a crank mechanism, distributes the roving threads along the axis of the spool 10, due to which the thread 15 on the spools is applied evenly over the entire radial surface.

Applying twisted roving to the barrel is carried out in different densities depending on the diameter of the rebar, which makes it possible to manufacture products for various consumer needs. So, the more densely the periodic profile is wound on the surface of the product (with one or more spools), the higher the characteristics of adhesion to concrete and the maximum strength for tearing out of concrete, which is a key advantage for laying rebar in columns, bridge supports, bridge pylons and other elements. This is achieved through the operation of the periodic profile, pressing the thread of the periodic profile to the power rod, due to which the necessary roughness is formed on the surface of the product.

Hence a much greater force is required to separate the periodic profile from the power rod, and therefore the characteristics of adhesion to concrete are improved. The main results of tests for strength and adhesion to concrete of the resulting products are presented in the Table.

After passing through the polymerization chamber 4, in which, at an elevated temperature of 200-350° C., depending on the diameter from 4 to 42 mm, polymerization and solidification of the polymer binder and a bundle of threads with a deposited periodic profile occur, a finished rod is obtained at the output.

Next, the rod enters the cooling unit 5. Cooling is carried out using air blowing and/or passing the product through a water-cooling bath. At the same time, when using air and water cooling, it is necessary to install first an air-cooling unit, and after it a water-cooling bath is installed so that the temperature of the product at the outlet of the polymerization chamber drops gradually, and the splitting of the rod due to a sharp temperature drop is excluded.

The rod then passes through the pulling device 6. With the shortness of the pulling device 6 is minimal, and can be 0.5-0.7 m/min (when releasing rebar with a diameter of 20 mm) a maximum of 5.55-6 m/min when releasing the rebar (diameter 5 mm). After that, the rod is cut by an automatic cutting device 7 and fed into the receiving tray or wound into the coils using a bay winder 8.

Examples of a particular embodiment of a method for manufacturing a claimed FRP composite rebar are not limited to those described above, wherein the components and units of the process line may be added, reordered, combined or combined in other implementation schemes.

In the manufacture of FRP composite rebar using the present method, for example, fiberglass roving 600 tex, 1200 tex, 2400 tex, 4800 tex, 9600 tex can be used. It can also be made of basalt fiber, and/or carbon fiber, and/or aramid fiber, and/or a combination thereof. The color of the resulting rebar is mainly depending on the color of the roving and the color of the binder-from light yellow to dark brown, it is also possible to add a color pigment to the compound to obtain the color of the product at the request of the consumer.

As follows from the test results, the implementation of the method makes it possible to obtain FRP composite rebar, which has improved quality characteristics of the finished product, increased strength for tearing out of concrete and, as a result, increased adhesion to concrete.

The proposed finished product is used mainly in the field of construction, for example: reinforcement of foundation slabs, strip foundation, scaffolding around buildings, it can also be used for strengthening works of structural elements like columns, beams, Reinforced concrete pavement and also bridge decks etc.

1. A method for manufacturing FRP composite rebar with a periodic profile, including pulling a formed and impregnated with a polymer binder cloth from roving threads through a squeezing device, forming a rod, periodic profile, polymerization, cooling and cutting of the product, characterized by the fact that after impregnation, on the radial surface of a rod formed from impregnated With a pre-tension roving binder, a periodic profile is formed from the roving threads that have undergone the process of pre-axial twisting, while the thread of the periodic profile is impregnated with a binder from the rod itself when applied.

2. The method according to claim 1, characterized in that the periodic profile is formed from a filament based on glass fiber and/or basalt fiber, and/or carbon fiber, and/or aramid fiber, and/or a combination thereof, which has undergone a pre-axial twisting process.

3. The method according to claim 1, characterized in that cooling is carried out by blowing air currents and/or passing the product through water cooling baths.

4. The method according to claim 1, differing in that the frequency of applying the profile increases with an increase in the diameter of the produced rebar.
